(19) United States
(12) Patent Application Publication
(10) Pub. No.: US 2011/0045725 A1
(43) Pub. Date: Feb. 24, 2011

(54) FILM-FORMING COMPOSITIONS, RELATED PROCESSES AND COATED SUBSTRATES

(75) Inventors: Shan Cheng, Sewickley, PA (US); Thomas R. Hockswender, Gibsonia, PA (US); Anthony M. Chasser, Allison Park, PA (US); James P. Rowley, Freeport, PA (US); Dennis A. Simpson, Sarver, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/545,889

(22) Filed: Aug. 24, 2009

(51) Int. Cl. B32B 5/02; C08L 83/00; C08L 63/00; C08L 67/00; B32B 21/08; B32B 15/092; B32B 17/10; B32B 27/06; B05D 1/36

(52) U.S. Cl. 442/59; 525/474; 525/451; 525/418; 428/413; 428/418; 428/417; 428/319.3; 427/407.1; 427/408; 427/410; 427/407.2; 427/412

(57) ABSTRACT

Film-forming coating compositions are disclosed. The composition comprises a) an epoxy-containing polymer system; and b) a polyacid curing agent comprising two acid functional groups per molecule; wherein the epoxy-containing polymer system comprises: (i) an epoxy resin comprising at least two epoxy functional groups per molecule and which is different from (ii); and (ii) an epoxy functional silsesquioxane. Also disclosed are processes for applying the film-forming composition to a basecoat, and substrates coated in part by a coating deposited from the film-forming compositions.

### FIELD OF THE INVENTION

The present invention relates to film-forming coating compositions comprising an epoxy functional silsesquioxane, related processes for applying the coating to a basecoat, and related coated substrates.

### BACKGROUND OF THE INVENTION

Color-plus-clear coating systems involving the application of a colored or pigmented basecoat to a substrate followed by the application of a transparent or clear topcoat to the basecoat have become popular as original finishes for automobiles. The color-plus-clear systems have outstanding gloss and distinctness of image (DOI), and the clear topcoat is particularly important for these properties.

The present invention provides film-forming compositions, which may be used in color-plus-clear coating systems in that they have improved abrasion and scratch resistance. The compositions also have good gloss and distinctness of image (DOI) so that the coating may be useful as an original finish for automobiles.

### SUMMARY OF THE INVENTION

In certain aspects, the present invention relates to film-forming coating compositions. These compositions comprise: a) an epoxy-containing polymer system; and b) a polyacid curing agent comprising at least two acid functional groups per molecule; wherein the epoxy-containing polymer system comprises: (i) an epoxy resin comprising at least two epoxy functional groups per molecule and which is different from (ii); and (ii) an epoxy functional silsesquioxane.

In other aspects, the present invention relates to processes for applying a composite coating to a substrate. These processes comprise: (a) applying an acid-catalyzed thermosetting film-forming composition to the substrate to form a basecoat; and (b) applying a clear film-forming composition to the basecoat wherein the film-forming composition comprises: (1) an epoxy-containing polymer system; and (2) a polyacid curing agent comprising at least two acid functional groups per molecule; wherein the epoxy-containing polymer system comprises: (i) an epoxy resin comprising at least two epoxy functional groups per molecule and which is different from (ii); and (ii) an epoxy functional silsesquioxane.

In certain non-limiting aspects, a cured coating deposited from the clear film-forming composition comprises: (1) a thickness of 0.1 to 5 mils, (2) an initial 20° gloss ranging between 70 and 90, (3) a 20° gloss after a dry abrasion scratch test ranging between 20 and 60; and (4) a 20° gloss after a car wash test ranging between 50 and 80.

In still other aspects, the present invention relates to a substrate coated at least in part with a cured coating deposited from a film-forming composition comprising a) an epoxy-containing polymer system; and b) a polyacid curing agent comprising at least two acid functional groups per molecule; wherein the epoxy-containing polymer system comprises: (i) an epoxy resin comprising at least two epoxy functional groups per molecule and which is different from (ii); and (ii) an epoxy functional silsesquioxane.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The film-forming compositions of the present invention may be curable compositions. The terms “curable” and “substantially cured” as used in connection with a curable composition means that any crosslinkable components of the composition are at least partially crosslinked after a curing process (e.g. heating). In certain embodiments of the present invention, the crosslink density (degree of crosslinking) of the crosslinkable components ranges from 5% to 100% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen. This method determines the glass transition temperature Tg and crosslink density of free films of coatings or polymers. These physical properties of a cured material are related to the structure of the crosslinked network.

The term “polymer” is meant to refer to prepolymers, oligomers, and homopolymers and copolymers. The prefix “poly” refers to two or more.

Unless stated otherwise, molecular weights are weight average molecular weights for polymeric materials indicated as “Mw” and obtained by gel permeation chromatography using polystyrene standards in an art-recognized manner, and referred to herein as “GPC Mw”.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

In that the film-forming compositions of the invention may be in powder form or in liquid form, the term “film-forming” is meant that an at least near continuous film, except perhaps for a few if any pin hole type marks, can be formed on at least a horizontal surface from either 1) the particulate polymeric material of a powder coating upon at least melting and curing at elevated temperatures; or 2) the polymeric material dispersed or solubilized in a solvent or carrier upon drying or evaporation of the solvent or carrier and/or curing of the polymeric material.

An aspect of the invention relates to a film-forming composition, comprising: a) an epoxy-containing polymer system; and b) a polyacid curing agent comprising at least two acid functional groups per molecule; wherein the epoxy-containing polymer system comprises: (i) an epoxy resin comprising at least two epoxy functional groups per molecule; and (ii) an epoxy functional silsesquioxane.

In non-limiting embodiments, the epoxy-containing polymer system comprises an epoxy resin comprising at least two epoxy functional groups per molecule. In non-limiting embodiments, this epoxy resin comprises an epoxy functional acrylic polymer. Examples of suitable epoxy functional acrylic polymers for use in the invention may be prepared from a methacrylate, styrene, and mixtures thereof. It should be noted that the various specific epoxy-functional acrylic resins prepared using methacrylate, styrene and mixtures thereof can have a particularly high glass transition temperature (Tg). Tg can be calculated as described by Fox in Bull. Amer. Physic. Soc., 1, 3, page 123 (1956). The calculated Tg of the epoxy-containing acrylic polymer is often sufficiently high such that, in conjunction with other components of the composition of the invention, a cured softening point of the film-forming composition is achieved. It is recognized that softening point temperatures are related to glass transition temperatures and that softening occurs during glass transition. More specifically, the epoxy functional acrylic polymers of the present invention may have a calculated Tg of greater than 20° C., more often greater than 50° C., or, in some cases, greater than 60° C.

The epoxy functional acrylic polymer of the invention may be a copolymer of an ethylenically unsaturated monomer having at least one, often, at least two epoxy groups and at least one polymerizable ethylenically unsaturated monomer which is free of epoxy groups.

Examples of ethylenically unsaturated monomers containing epoxy groups are those containing 1,2-epoxy groups, such as glycidyl acrylate, glycidyl methacrylate and allyl glycidyl ether.

Examples of ethylenically unsaturated monomers which do not contain epoxy groups are alkyl esters of acrylic and methacrylic acid containing from 1 to 20 atoms in the alkyl group. Specific examples of these acrylates and methacrylate include methyl methacrylate, ethyl methacrylate, butyl methacrylate, ethyl acrylate, butyl acrylate and 2-ethylhexyl acrylate. Examples of other copolymerizable ethylenically unsaturated monomers are vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate. Acid and anhydride functional ethylenically unsaturated monomers such as acrylic acid, methacrylic acid or anhydride, itaconic acid, maleic acid or anhydride, or fumaric acid may be used. Amide functional monomers including acrylamide, methacrylamide, and N-alkyl substituted (meth)acrylamides are also suitable.

For the epoxy functional acrylic resin, the epoxy group-containing ethylenically unsaturated monomer is often used in amounts of from 20 to 90, or in some cases from 30 to 70 percent by weight of the total monomers used in preparing the epoxy functional acrylic polymer. Of the remaining polymerizable ethylenically unsaturated monomers, often from 10 to 80 percent, such as from 30 to 70 by weight of the total monomers are the alkyl esters of acrylic and methacrylic acid.

In certain embodiments, the epoxy functional acrylic resin of the present invention has a relatively low molecular weight. This aspect of the epoxy functional acrylic resin for the film-forming composition of the invention is useful in achieving acceptable stability and high solids content. More specifically, the epoxy functional acrylic resin of the present invention may have a weight average molecular weight of less than 20,000, such as less than 10,000, in some cases, less than 5,000, and in some cases, less than 3,000 GPC Mw.

For the epoxy functional acrylic resin, the acrylic polymer may be prepared by solution polymerization techniques in the presence of suitable catalysts such as organic peroxides, such as t-butyl perbenzoate, t-amyl peracetate or ethyl-3,3-di(t-amyl peroxy)butyrate or azo compounds, such as benzoyl peroxide, N,N′-azobis(isobutyronitrile) or alpha, alpha-dimethylazobis(isobutyronitrile). The polymerization can be carried out in an organic solution in which the monomers are soluble. Suitable solvents are aromatic solvents such as xylene and toluene, ketones such as methyl amyl ketone or ester solvents such as ethyl 3-ethoxypropionate. Alternately, the acrylic polymer may be prepared by aqueous emulsion or dispersion polymerization techniques.

Such epoxy functional acrylic polymers disclosed herein above for the epoxy containing polymer system of the film-forming composition of the invention are described in U.S. Pat. No. 5,196,485 at col. 3, line 32 to col. 4, line 8, the cited portion of which being incorporated herein by reference.

Suitable epoxy functional acrylic polymers for use in the film-forming composition of the invention also include graft copolymers of acrylic polymers and polyepoxides.

Epoxy-acrylic graft copolymers can be prepared by first preparing a suitable polyepoxide such as that polyepoxide polymer as described in Column 3, lines 66-67 to column 4, lines 27 of U.S. Pat. No. 7,459,504 B2, the cited portion of which being incorporated herein by reference. An acrylic polymer is then prepared by polymerizing ethylenically unsaturated monomers in the presence of the polyepoxide polymer under conditions that produce some molecules containing both polyepoxide and polyacrylic fractions. Optionally, the ethylenically unsaturated monomers may include an ethylenically unsaturated epoxy functional monomer such as glycidyl acrylate, glycidyl methacrylate, allyl glycidyl ether and/or methallyl glycidyl ether. The ethylenically unsaturated monomers may include, for example, 5 to 25 percent, based on the total weight of ethylenically unsaturated monomers, of ethylenically unsaturated epoxy functional monomer.

A method of producing an epoxy-acrylic graft copolymer is to utilize an initiator for the acrylic polymerization that produces highly energetic free radicals capable of generating grafting sites on the polyepoxide polymer. Suitable initiators include, for example, hydrogen peroxide, benzoyl peroxide and t-butyl perbenzoate. Further methods for producing a graft polymer are discussed in the aforesaid U.S. Pat. No. 7,459,504 B2 at col. 4, line 36 to col. 5, line 15, the cited portion of which being incorporated herein by reference.

In non-limiting embodiments, a suitable epoxy functional acrylic polymer for use in the epoxy containing polymer system of the film-forming composition of the present invention comprises the reaction product of reactants comprising butyl methacrylate, methyl methacrylate, styrene, glycidyl methacrylate and an alpha methyl styrene dimer and often having a GPC Mw less than 3,000. Other suitable epoxy-containing acrylics for use in the epoxy containing polymer system of the film-forming composition of the invention include those disclosed in the aforesaid U.S. Pat. No. 5,196,485, particularly in Examples A through E, the cited portion of which being incorporated herein by reference.

Instead of, or in addition to, an epoxy functional acrylic polymer, other classes of polyepoxides may be used as an epoxy resin in the epoxy-containing polymer system of the film-forming compositions of the present invention.

Other suitable classes of polyepoxides include epoxy ethers obtained by reacting an epihalohydrin, such as epichlorohydrin, with a polyphenol in the presence of an alkali. Suitable polyphenols include resorcinol, catechol, hydroquinone, bis(4-hydroxyphenyl)-2,2-propane (Bisphenol A), bis(4-hydroxyphenyl)-1,1-isobutane, bis(4-hydroxyphenyl)-1,1-ethane, bis(2-hydroxyphenyl)-methane, 4,4-dihydroxybenzophenone, and 1,5-dihydroxynaphthalene. The diglycidyl ether of Bisphenol A is sometimes especially suitable.

Other suitable polyepoxides include polyglycidyl ethers of polyhydric alcohols. These compounds may be derived from polyhydric alcohols such as ethylene glycol, propylene glycol, butylene glycol, 1,6-hexylene glycol, neopentyl glycol, diethylene glycol, glycerol, trimethylol propane, and pentaerythritol. These compounds may also be derived from polymeric polyols such as polypropylene glycol.

Examples of other suitable polyepoxides include polyglycidyl esters of polycarboxylic acids. These compounds may be formed by reacting epichlorohydrin or another epoxy material with an aliphatic or aromatic polycarboxylic acid such as succinic acid, adipic acid, azelaic acid, sebacic acid, maleic acid, 2,6-naphthalene dicarboxylic acid, fumaric acid, phthalic acid, tetrahydrophthalic acid, hexahydrophthalic acid, or trimellitic acid. Dimerized unsaturated fatty acids containing about 36 carbon atoms (Dimer Acid) and polymeric polycarboxylic acids such as carboxyl terminated acrylonitrile-butadiene rubber may also be used in the formation of these polyglycidyl esters of polycarboxylic acids.

Polyepoxides derived from the epoxidation of an olefinically unsaturated alicyclic compound are also suitable for use as an epoxy resin in the film-forming curable compositions of the present invention. These polyepoxides are nonphenolic and are obtained by epoxidation of alicyclic olefins with, for example, oxygen, perbenzoic acid, acid-aldehyde monoperacetate, or peracetic acid. Such polyepoxides include the epoxy alicyclic ethers and esters well known in the art.

Other suitable polyepoxides include epoxy novolac resins. These resins are obtained by reacting an epihalohydrin with the condensation product of aldehyde and monohydric or polyhydric phenols. A typical example is the reaction product of epichlorohydrin with a phenol-formaldehyde condensate.

The film-forming compositions of the present invention may comprise one polyepoxide or mixtures of polyepoxides.

In certain embodiments, the epoxy resin of the film-forming composition of the invention may be present in an amount of at least 0.01 percent by weight based on the total weight of the resin solids of the film-forming composition. In certain embodiments, the epoxy resin of the film-forming composition of the invention may be present in amounts of 10 percent by weight to 90 percent by weight, such as from 20 percent by weight to 80 percent by weight, or, in some cases, from 40 percent by weight to 70 percent by weight based on the total weight of the resin solids of the film-forming composition.

The epoxy-containing polymer system of the compositions of the invention also comprises an epoxy-functional silesquioxane. As used herein, the term “epoxy-functional silsesquioxane” refers to silsesquioxanes comprising epoxy functional groups. In certain embodiments, the coating compositions of the present invention comprise an epoxy-functional silsesquioxane comprising a plurality of epoxy functional groups, i.e., two or more epoxy functional groups per molecule. In certain embodiments of the present invention, the coating composition comprises an epoxy-functional silsesquioxane comprising more than two epoxy functional groups.

As known in the art, a silsesquioxane is a compound with the empirical chemical formula RSiO_{1.5} where Si is the element silicon, O is oxygen and R is an organic functional group. The silsesquioxane may be a ladder structure, a cage structure, or a cyclic structure. In the invention, the epoxy functional silsesquioxane often has an octahedral cage structure having at least 8 Si atoms. In the invention, the organic functional groups, i.e. the R groups of the epoxy-functional silsequioxane, comprise reactive epoxy groups. The term “reactive” refers to a functional group capable of undergoing a chemical reaction with itself and/or other functional groups spontaneously or upon the application of heat or in the presence of a catalyst or by any other means known to those skilled in the art. The epoxy functional silsesquioxane used in the compositions of the present invention can be in liquid form.

In certain embodiments, the epoxy functional silsesquioxane will be present in an amount of at least 0.01 percent by weight based on the total weight of the resin solids of the film-forming composition. In certain embodiments, the epoxy functional silsesquioxane will be present in amounts of 5 percent by weight to 50 percent by weight, such as from 10 percent by weight to 30 percent by weight based on the total weight of the resin solids of the film-forming composition. The amount of epoxy functional silsesquioxane in the compositions of the present invention may range between any combinations of the cited values inclusive of the recited values.

A suitable epoxy functional silsesquioxane for use in the compositions of the present invention comprises propyl glycidyl silsesquioxane available from The Welding Institute (TWI), Cambridge, UK. A further example of an epoxy functional silsesquioxane suitable in the film-forming compositions of the invention is described in United States Publication No. 2007/0122636 A1 at [0025] to [0089], the cited portion of which being incorporated herein by reference.

In certain embodiments, the film-forming compositions of the present invention comprise a polyacid curing agent comprising at least two acid functional groups per molecule, in some instances, three or more and in other instances, four or more, such acid groups being reactive with the epoxy-containing polymer system to form a crosslinked coating as indicated by its resistance to organic solvent. The parameter of at least two acid groups per molecule is intended to encompass mixtures of polyacid curing agents, in which di-functional curing agents are mixed with tri-or higher functionality polyacid curing agents. Polyacid curing agent mixtures including up to 50 percent of a di-functional curing agent with a tri-functional curing agent are suitable. Higher percentages of di-functional material can be useful with the remainder of the curing agent mixtures being higher than tri-functional or if the epoxy-containing polymer system component is highly functional. In some embodiments, the acid functionality is carboxylic acid, although acids such as phosphorus-based acid may be used. In some embodiments, the polyacid curing agent in the film-forming composition of the invention comprises a carboxylic acid terminated material having on average greater than two carboxylic acid groups per molecule. Among the polyacid curing agents which may be used include carboxylic acid group-containing polymers such as acrylic polymers, polyesters, and polyurethanes; oligomers such as ester group-containing oligomers and monomers.

Polyacid curing agents suitable in the film-forming composition of the invention include ester group-containing oligomers. Examples include half-esters formed from reacting polyols and 1,2-acid anhydrides or acid functional polyesters derived from polyols and polyacids or anhydrides. The half-esters are sometimes preferred because they are relatively very low molecular weight and are quite reactive with epoxy functionality, often enabling the formulation of high solids fluid compositions while maintaining outstanding properties such as gloss and distinctness of image (DOI).

The half-ester may be obtained by reaction between a polyol and a 1,2-acid anhydride under conditions sufficient to ring open the anhydride forming the half-ester with substantially no polyesterification occurring. Such reaction products are of relatively low molecular weight with narrow molecular weight distributions and low viscosity and provide lower volatile organic contents in the coating composition while still providing for excellent properties in the resultant coating. By substantially no polyesterification occurring means that the carboxyl groups formed by the reaction of the anhydride are not further esterified by the polyol in a recurring manner. By this is meant that less than 10, and in some instances, less than 5 percent by weight high molecular weight polyester is formed.

Two reactions may occur in combining the anhydride and the polyol together under suitable reaction conditions. A further description of this desired reaction mode involving ring opening appears in column 5, lines 52 to column 6, line 38 of the aforesaid U.S. Pat. No. 5,196,485.

As disclosed in column 6, lines 39 to 59 of the aforesaid U.S. Pat. No. 5,196,485, the cited portion of which being incorporated herein by reference, among the anhydrides which can be used in formation of the desired polyesters are those which, exclusive of the carbon atoms and the anhydride moiety, contain from 2 to 30 carbon atoms. Examples include aliphatic, including cycloaliphatic, olefinic and cyclo-olefinic anhydrides and aromatic anhydrides. Substituted aliphatic aromatic anhydrides are also included with the definition of aliphatic and aromatic provided the substituents do not adversely affect the reactivity of the anhydride or the properties of the resultant polyester. Examples of substituents would be chloro, alkyl and alkoxy. Examples of anhydrides include succinic anhydride, methylsuccinic anhydride, dodecenyl succinic anhydride, octadecenylsuccinic anhydride, phthalic anhydride, tetrahydrophthalic anhydride, methyltetrahydrophthalic anhydride, hexahydrophthalic anhydride, alkyl hexahydrophthalic anhydrides such as methylhexahydrophthalic anhydride, tetrachlorophthalic anhydride, endomethylene tetrahydrophthalic anhydride, chlorendic anhydride, itaconic anhydride, citraconic anhydride and maleic anhydride.

Among the polyols which can be used are simple polyols, that is, those containing from 2 to 20 carbon atoms, as well as oligomeric polyols and polymeric polyols such as polyester polyols, polyurethane polyols and acrylic polyols.

Among the simple polyols are diols, triols, tetrols and mixtures thereof. Examples of the polyols are those containing from 2 to 10 carbon atoms such as aliphatic polyols. Specific examples include but are not limited to the following: di-trimethylol propane (bis(2,2-dimethylol)dibutylether); pentaerythritol; 1,2,3,4-butanetetrol; sorbitol; trimethylol propane; trimethylol ethane; 1,2,6-hexanetriol; glycerine; trishydroxyethyl isocyanurate; dimethylol propionic acid; 1,2,4-butanetriol; TMP/epsilon-caprolactone triols; ethylene glycol; 1,2-propanediol; 1,3-propanediol; 1,4-butanediol; 1,5-pentanediol; 1,6-hexanediol; neopenthyl glycol; diethylene glycol; dipropylene glycol; 1,4-cyclohexanedimethanol and 2,2,4-trimethylpentane-1,3 diol.

With regard to oligomeric polyols, suitable polyols are polyols made from reaction of diacids with triols, such as trimethylol propane/cyclohexane diacid and trimethylol propane/adipic acid.

With regard to polymeric polyols, the polyester polyols are prepared by esterification of an organic polycarboxylic acid or anhydride thereof with organic polyols and/or an epoxide. Usually, the polycarboxylic acids and polyols are aliphatic or aromatic dibasic acids or acid anhydrides and diols.

The polyols which are usually employed in making the polyester include trimethylol propane, di-trimethylol propane, alkylene glycols such as ethylene glycol, neopentyl glycol and other glycols such as hydrogenated bisphenol A, cyclohexanediol, cyclohexanedimethanol, the reaction products of lactones and diols, for example, the reaction product of epsilon caprolactone and ethylene glycol, hydroxyl-alkylated bisphenols, polyester glycols, for example, poly(oxytetramethylene)glycol and the like.

The acid component of the polyester consists primarily of monomeric carboxylic acids or anhydrides having 2 to 18 carbon atoms per molecule. Among the acids which are useful are phthalic acid, isophthalic acid, terephthalic acid, tetrahydrophthalic acid, hexahydrophthalic acid, methylhexahydrophthalic acid, adipic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid. However, the use of these higher functionality polycarboxylic acids is not preferred because of resultant high viscosities.

Further details of polyacid curing agents for use in the film-forming composition of the invention are disclosed in the aforesaid U.S. Pat. No. 5,196,485.

In certain embodiments of the invention, the polyacid curing agent comprises a carboxylic acid functional resin. In certain embodiments of the invention, the carboxylic acid functional resin comprises the reaction product of reactants comprising methylhexahydrophthalic anhydride and di-trimethyol propane. In some instances, the reaction product is borne in an organic solvent mixture consisting of N-amyl alcohol, N-propanol and Aromatic 100. Often, the molecular weight of the polyacid curing agent is relatively low and it is quite reactive with epoxy functionality enabling the formulation of high solids fluid compositions while maintaining outstanding properties such as gloss and distinctness of image (DOI). Thus, in some instances, the molecular weight of the carboxylic acid functional resin may be 900 GPC Mw or less.

Other suitable polyacid curing agents for use in the film-forming composition of the invention include a polyacid half-ester of di-trimethylolpropane and methylhexahydrophthalic anhydride, a polyacid half-ester of trimethylolpropane and methylhexahydrophthalic anhydride, a polyacid half-ester of neopentyl glycol and methylhexahydrophthalic anhydride, a polyacid acrylic polymer having methacrylic acid functionality, and 1-octene/maleic anhydride/ethanol copolymer such as those disclosed in Examples F through J of the aforesaid U.S. Pat. No. 5,196,485, the cited portion of which being incorporated herein by reference.

One or more polyacid curing agents may be used in the film-forming composition of the invention. In certain non-limiting embodiments, a first polyacid curing agent comprises carboxylic acid functional resin and optionally, a second polyacid curing agent comprises the reaction product of reactants comprising 1-octene, maleic anhydride copolymer and ethanol. This second polyacid curing agent may be similar to that disclosed in Example J of the aforesaid U.S. Pat. No. 5,196,485.

In certain non-limiting embodiments of the invention, the polyacid curing agent of the film-forming composition of the invention may be used in amounts of from 20 to 90, such as from 30 to 70 percent by weight, based on the total weight of the resin solids of the film-forming composition.

In certain embodiments of the present invention, the film-forming composition may include a catalyst. Since the high functionality associated with the epoxy-containing polymer system and the polyacid curing agent provide for sufficient cure response, in a certain embodiment, the composition of the present invention may contain a minimal amount of catalyst such that the composition is stable for a time sufficient to allow formulation of the composition as a single-component composition. More specifically, in a certain non-limiting embodiment, the composition of the present invention has no or only small amounts of basic esterification catalyst such that the composition is stable for a time sufficient to allow formulation of the composition as a single-component composition.

A number of basic esterification curing catalysts are known in the art. In certain embodiments, the present invention may be substantially free of all such catalysts. Such catalysts include, secondary amine catalysts such as piperidine, tertiary amine catalysts such as N,N-dimethylaniline; ammonium compounds, including tetrabutylammonium bromide, tetrabutylammonium hydroxide, and tetrabutylammonium acetate; phosphonium compounds, including ethyltriphenylphosphonium acetate and tetrabutyl-phosphonium bromide; and other ammonium and phosphonium salts.

A further curing catalyst which may be used in certain embodiments of the film-forming composition of the present invention is a zinc catalyst which cures the top clear coating. A suitable zinc catalyst for the film-forming composition of the invention is available under the trademark NACURE® XC-9206 from King Industries, Inc., Connecticut. When used, this ingredient is often present at a minimal level, e.g. 0.02 or less weight percent based on the total weight of the resin solids of the film-forming composition. The amount used is enough to provide stability of the composition.

In addition to the foregoing identified catalysts, it is recognized that other common ingredients in coating formulations can have incidental catalytic properties even though the ingredients are added for other purposes. For example, in certain embodiments, the film-forming compositions of the invention may include hindered-amine light stabilizers, such as TINUVIN® 292 and TINUVIN® 123, available from Ciba Specialty Chemicals. When used, these ingredients are often present in an amount ranging from 0.5 to 1 percent by weight and in some instances, up to 2 percent by weight based on the total weight of resin solids of the film-forming composition. It is recognized that such compositions may have a small catalytic effect. It is also expressly recognized that compositions of the present invention which are substantially free from basic esterification catalyst can include such compounds provided that the composition otherwise is within parameters of the present invention relating to stability of the composition and absence of cure inhibition.

In certain embodiments, the film-forming compositions of the present invention may include an aminoplast resin, which may improve resistance to water spotting. The term “etch resistance” refers to a composition's resistance to acid etching and to water spotting. While aminoplast resins often improve resistance to water spotting, it is recognized that high levels of aminoplast resins can degrade the acid etch resistance properties of the composition. Typically, when present, the aminoplast resin may be present in the film-forming compositions of the present invention in amounts up to 15 percent by weight based on the total weight of the resin solids of the film-forming composition.

Aminoplast resins are condensation products of amines or amides with aldehydes. Examples of suitable amine or amides are melamine, benzoguanamine, urea and similar compounds. Generally, the aldehyde employed is formaldehyde, although products can be made from other aldehydes such as acetaldehyde and furfural. The condensation products contain methylol groups or similar depending on the particular aldehyde employed. Often, these methylol groups are etherified by reaction with an alcohol. Various alcohols employed include monohydric alcohols containing from 1 to 4 carbon atoms such as methanol, ethanol, isopropanol and n-butanol, with methanol being preferred. Aminoplast resins are commercially available from Cytec Industries, Inc. under the trademark CYMEL® and from Ineos Melamines under the trademark RESIMENE®. A suitable aminoplast resin is methylated melamine-formaldehyde condensate. A suitable methylated melamine-formaldehyde condensate is a melamine resin available under the trademark CYMEL® 202 from Cytec Industries, Inc. When used, this ingredient may be present in an amount ranging from 2 to 15 percent by weight and in some instances, in an amount up to 20 percent by weight based on the total weight of resin solids of the film-forming composition.

In certain embodiments, the film-forming composition of the invention may also include other optional ingredients, such as plasticizers, anti-oxidants, crosslinkers, UV light absorbers, flow controllers, defoamers, solvents, and thickening agents. A particularly useful class of cross-linkers for use in the film-forming compositions of the invention includes copolymers of alpha-olefins and olefinically unsaturated anhydrides, such as a 1-octene and maleic anhydride copolymer. In such a cross-linker, the anhydride is often opened with ethanol to form an ester and an acid to maintain stability. Examples of these materials and amounts are further described in U.S. Pat. No. 4,927,868 at col. 3, line 40 to col. 40, line 50, the cited portion of which being incorporated herein by reference. This cross-linker may also act as a curing agent and is referred to herein as a second polyacid curing agent for use in the film-forming compositions of the present invention. A suitable epoxy cross-linker for use as a second polyacid curing agent in the invention is a reaction product of reactants comprising 1-octene, maleic anhydride copolymer, and ethanol having a GPC Mw less than 3000, wherein the reactants further comprise methanol, and wherein the reaction product is borne in a solvent mixture of butyl acetate and N-butanol. When used, this ingredient is often present in the film-forming composition in an amount up to 20 percent by weight based on the total weight of resin solids of the film-forming composition.

A suitable thickening agent for use in the film-forming composition of the invention is fumed silica which often is dispersed in the polyacid curing agent used in the film-forming compositions of the present invention. More particularly, in an embodiment of the present invention, fumed silica is dispersed in carboxylic acid resin, such as that described herein above. A suitable fumed silica for use in the film-forming compositions of the present invention is sold under the trademark CAB-O-SIL® CT 1206 of the Cabot Corporation. In certain embodiments of the present invention, 8.9 parts fumed silica (8.9 parts) is dispersed in 51.6 parts amyl alcohol and 39.5 parts carboxylic acid resin. In an embodiment of the invention, the carboxylic acid resin is the reaction product of 21.8% trimethylol propane, 54.9% methyl hexahydrophthalic anhydride and 23.3% trimethylol propane, which reaction product is diluted with 95% butyl acetate/5% N-propanol solvent mixture and which carboxylic acid resin has GPC Mw of 580. When used, this ingredient is often present in the film-forming compositions of the invention in an amount of up to 5 percent by weight, including silica and dispersing resin, based on the total weight of resin solids of the film-forming compositions.

Suitable UV light absorbers for use in the film-forming compositions of the invention include TINUVIN® 928 available from Ciba Specialty Chemicals Corporation and CHISORB® 328 available from Chitec Chemical Co., Ltd. (Taiwan). When used, these ingredients are often present in an amount of up to 2 to 3 percent by weight based on the total weight of resin solids of the film-forming composition. In some instances, this ingredient may be up to 5 percent by weight based on the total weight of resin solids of the film-forming composition. A suitable flow controller includes an acrylic flow additive available under the trademark MULTIFLOW® from Cytec Industries, Inc. When used, this ingredient is often present in an amount of less than 1 percent by weight based on the total weight of resin solids of the film-forming composition. A suitable defoamer is a non-ionic defoamer available under the trademark OX-60 from Kusumoto Chemicals. When used, this ingredient will be present in an amount of less than 1 percent by weight based on the total weight of resin solids of the film-forming composition. Suitable solvents include ethyl 3-ethoxyropionate available from Eastman Chemical Company and N-amyl alcohol available from Dow Chemical Company. When used, these ingredients will be present in an amount of up to 50 percent by weight based on the total weight of resin solids of the film-forming composition.

In certain embodiments, the film-forming compositions of the present invention are used to formulate clear coats for use in a color-plus-clear application. In a color-plus-clear application, a composite coating is applied to a substrate. The process comprises applying to the substrate a pigmented or colored film-forming composition to form a base coat and applying to the base coat the film-forming compositions of the present invention to form a transparent top coat over the base coat.

In certain embodiments, the base coat can be any of the compositions useful in coating applications, particularly automotive applications in which the color-plus-clear coating applications have found their most use. A base coat composition conventionally comprises a resinous binder and a pigment to act as a colorant. Particularly useful resinous binders are acrylic polymers, polyesters including alkyds, and polyurethanes.

In certain embodiments, the base coat composition and the film-forming composition of the present invention can be applied to various substrates to which they adhere. The base coat composition and the film-forming composition of the invention can be applied by conventional means including brushing, dipping, flow coating, spraying and the like, but they are most often applied by spraying. The usual spray techniques and equipment for air spraying and electrostatic spraying and either manual or automatic methods can be used.

In certain embodiments, the base coat and the film-forming composition of the present invention are often applied to any substrate comprising wood, metal, glass, cloth, plastic, foam, including elastomer substrates, and the like. They are particularly useful in applying over metal and elastomeric substrates that are found on motor vehicles.

The base coat composition contains resinous binders which can be an organic solvent-based material such as those described in U.S. Pat. No. 4,220,679 (column 2, line 24, through column 4, line 40.) Also, water based coating compositions such as those described in U.S. Pat. Nos. 4,147,679 and 4,403,003 can also be used as the binder in the base coat compositions. The resinous binder for the base coat can also be the curable composition of the present invention.

The base coat composition may also contain pigments including metallic pigmentation to give it color. Examples of suitable pigmentations for the base coat are described in the aforesaid U.S. Pat. Nos. 4,147,679 and 4,220,679.

During application of the base coat to the substrate, a film of the base coat is formed on the substrate typically in a thickness of 0.1 (2.5 microns) to 5 mils (125 microns), and often 0.1 (2.5 microns) to 2 mils (50 microns).

After forming a film of the base coat on the substrate, solvent, that is, organic solvent and/or water, is often driven out of the base coat film by heating or simply an air drying period before application of the clear coat of the present invention. Often, the heating step will for a short period of time to insure that the clear top coat composition can be applied to the base coat without the former dissolving the base coating composition. Suitable drying conditions will depend on the particular base coat composition, on the ambient humidity with certain water-based compositions, but in general a drying time of from 1 to 15 minutes at a temperature of 70°-175° F. (21-79° C.) will be adequate to insure that mixing of the two coats is minimized. At the same time, the base coat film is often adequately wetted by the clear top coat composition so that satisfactory inter-coat adhesion can be obtained. Also, more than one base coat and more than one top coat may be applied to develop optimum appearance. Usually between coats, the previously applied base coat or top coat is flashed, that is, exposed to ambient conditions for 1 to 20 minutes.

After application of the basecoat, the film-forming composition of the present invention can be applied to the basecoated substrate by any of the conventional coating techniques discussed herein above. In some embodiments spray applications may be used since such applications give the best gloss. As discussed herein above, any of the known spray techniques may be employed, such as compressed air spraying, electrostatic spraying and either manual or automatic methods. Prior to application of a topcoat, it is possible to air flash the basecoated substrate for a short amount of time, typically ranging from 1 to 5 minutes. Optionally, the basecoated substrate can be heat flashed between application of the base and the topcoat.

In certain embodiments, after application of the topcoat composition to the basecoat, which topcoat is the film-forming composition of the present invention, the coated substrate is heated to cure the coating layers. In the curing operation, solvents are driven off and the film-forming material of the topcoat and/or the basecoat is crosslinked with the acid of any cross-linking agents present. The heating or curing operation is usually carried out at a temperature in the range of from 250° F. to 400° F. (121° C. to 204° C.), and more often in the range of from 260° F. to 325° F. (127° C. to 163° C.). It should be noted that at higher curing temperatures, typically above 260° F. (127° C.), and more often above 275° F. (135° C.), other parameters of the present invention can be adjusted because of improved crosslinking from the higher curing temperature. For example, lower functionality epoxy-based resins and/or additional polyacid curing agents may be used. In some embodiments, the thickness of the topcoat will be from 0.5 (12.5 microns) to 5 mils (125 microns), and in some instances will range from 1.2 (30 microns) to 3 mils (75 microns).

The present invention will be further described by reference to the following examples which are presented for the purpose of illustration only and are not intended to limit the scope of the invention.

The following examples illustrate the film-forming compositions of the present invention and compare the appearance and physical properties, such as hardness, gloss and distinctness of image (DOI) of such compositions with a comparative composition outside the scope of the present invention.

### EXAMPLES

### Examples 1, 2 and 3

Table 1 contains the clear coating formulations for a film-forming composition for a topcoat. Example 1 (Comparative) represents a formulation for a standard clear coating and is a comparative example. Examples 2 and 3 (Invention) represent formulations for the film-forming topcoat compositions of the invention. Example 2 (Invention) contains 10 percent by weight, based on the total weight of the resin solids of the film-forming composition, of an epoxy silsesquioxane. Example 3 (Invention) contains 20 percent by weight, based on the total weight of the resin solids of the film-forming composition, of an epoxy silsesquioxane. In Examples 2 and 3 (Invention) the epoxy silsesquioxane was propyl glycidyl silsesquioxane. The clear coat compositions were made by adding each ingredient into a steel container, i.e. a can, under mild stirring conditions with a steel stirring blade.

The clear coating compositions were spray applied using a SPRAYMATION machine onto 4 inch by 12 inch steel panels that were coated with cured ELECTROCOAT (ED 6060C) available from ACT Test Panels, Inc. of Hillsdale, Mich. A waterborne black color coat (EVH-8555) available from PPG Industries, Inc. was spray applied onto the coated panels with a total dry film thickness of 0.58 mils (14.5 microns) before application of the clear coating compositions. The waterborne black color coat was dehydrated for five minutes at 176° F. (80° C.) before application of the clear coating compositions. After application of the clear coating composition onto each steel panel and a ten minute room temperature flash applied to each steel panel, the entire layering system of each panel was baked for thirty minutes at 285° F. (141° C.).

The amounts of the components in Table 1 are in grams.

TABLE 1

| Component | Example 1 | Example 2 | Example 3 |
|---|---|---|---|
| Ethyl 3-Ethoxypropionate¹ | 25.26 | 28.60 | 31.60 |
| TINUVIN 928² | 1.97 | 1.97 | 1.97 |
| CHISORB 328³ | 0.69 | 0.69 | 0.69 |
| TINUVIN 123⁴ | 0.99 | 0.99 | 0.99 |
| N-Amyl Alcohol⁵ | 12.23 | 12.23 | 12.23 |
| Fumed Silica Dispersed in | 11.04 | 11.04 | 11.04 |
| Carboxylic Acid Resin⁶ | | | |
| Acrylic Resin with Epoxy | 77.65 | 60.16 | 42.58 |
| Functional Groups⁷ | | | |
| Propyl Glycidyl Silsesquioxane⁸ | 0 | 10.00 | 20.00 |
| CYMEL 202⁹ | 7.39 | 7.39 | 7.39 |
| Polymer of 1-Octene/Maleic | 10.61 | 10.61 | 10.61 |
| Anhydride/Ethanol¹⁰ | | | |
| Carboxylic Acid Functional Resin¹¹ | 52.82 | 54.69 | 56.64 |
| MULTIFLOW¹² | 0.99 | 0.99 | 0.99 |
| OX-60¹³ | 0.05 | 0.05 | 0.05 |
| NACURE XC-9206¹⁴ | 2.45 | 2.45 | 2.45 |

¹Solvent available from Eastman Chemical Company.
²UV absorber available from Ciba Specialty Chemicals.
³UV absorber available from Chitec Chemical Company.
⁴Hindered amine light stabilizer available from Ciba Specialty Chemicals.
⁵Solvent available from Dow Chemical Company.
⁶CAB-O-SIL CT 1206 Fumed Silica available from Cabot Corporation (8.9 parts) dispersed in amyl alcohol (51.6 parts) and a carboxylic acid resin (39.5 parts). The carboxylic acid resin is the reaction product of 21.8% trimethylol propane, 54.9% methyl hexahydrophthalic anhydride and 23.3% trimethylol propane diluted with 95% butyl acetate/5% N-propanol solvent mixture and with a GPC Mw = 580.
⁷Acrylic resin with epoxy groups made from 40.8% butyl methacrylate, 0.2% methyl methacrylate, 7.0% styrene, 50.0% glycidyl methacrylate, and 2.0% MSD-100 alpha methyl styrene dimer using N-amyl propionate solvent and with a GPC Mw = 2600.
⁸An epoxy functional silsesquioxane made by The Welding Institute of Cambridge, UK.
⁹Melamine resin available from Cytec Industries, Inc.
¹⁰Reaction product of 81.8% 1-octene-maleic anhydride copolymer, 16.5% ethanol and 1.7% methanol diluted with 85% butyl acetate and 15% N-butanol solvents and with Mw = 2790.
¹¹Reaction product of 72.2% methyl hexahydrophthalic anhydride and 27.8% di-trimethyol propane diluted with a solvent mixture consisting of 59.0% N-amyl alcohol, 25.0% N-propanol and 16.0% aromatic 100 and with a GPC Mw = 829.
¹²Acrylic flow additive available from Cytec Industries, Inc.
¹³Non-ionic defoamer available from Kusumoto Chemicals.
¹⁴Zinc catalyst available from King Industries.

Table 2 provides a summary of the appearance and physical properties obtained for the clear coatings of Examples 1-3. The epoxy silsesquioxane containing clear coatings of Examples 2 and 3 (Invention) were lower in hardness and provided a higher level of dry abrasive and car wash scratch resistance properties compared to the standard clear coating of Example 1 (Comparative).

TABLE 2
APPEARANCE AND PHYSICAL PROPERTIES

| | CLEAR | | | | 20° Gloss | 20° Gloss |
|---|---|---|---|---|---|---|
| | FILM | | | | After Dry | after Car |
| | THICKNESS¹ | 20° | TRICOR | FISCHER | Abrasion | Wash |
| CLEAR | (mils) | GLOSS² | DOI³ | Microhardness⁴ | Test⁵ | Test⁶ |
| Example 1 | 1.84 | 84 | 98 | 124 | 28 | 48 |
| Example 2 | 1.96 | 77 | 86 | 114 | 28 | 57 |
| Example 3 | 1.87 | 79 | 98 | 108 | 45 | 64 |

¹Dry film thickness measured using FISCHER DELTACOPE made by Fischer Technology, Inc. of Windsor, CT.
²NOVO GLOSS statistical 20° Glossmeter available from Paul N. Gardner Company, Inc. of Pompano Beach, Florida.
³DOI meter available from Tricor Systems, Inc. of Elgin, Illinois.
⁴Microhardness Instrument available from Helmut Fischer GMBH & Company of Sindelfingen, Germany.
⁵Dry abrasive scratch test based upon ten double rubs of Nine Micron Polishing Paper available from 3M of St Paul, Minnesota. The polishing paper is attached to the arm of a CM-5 AATCC CROCKMETER machine available from ATLAS Electric Devices Company of Chicago, Illinois. The 20° Gloss of the clear coating is measured before and after ten double rubs of the polishing paper on the clear surface.
⁶Lab Car Wash test machine available from AMTEC-KISTLER GmbH of Prittriching, Germany. The 20° Gloss is measured before and after 10 cycles of lab car washing.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A film-forming composition, comprising:
a) an epoxy-containing polymer system; and
b) a polyacid curing agent comprising at least two acid functional groups per molecule;
wherein the epoxy-containing polymer system comprises:
(i) an epoxy resin comprising at least two epoxy functional groups per molecule and which is different from (ii); and
(ii) an epoxy functional silsesquioxane.

2. The composition of claim 1 wherein the epoxy functional silsesquioxane comprises at least two epoxy functional groups per molecule.

3. The composition of claim 1 wherein the epoxy functional silsesquioxane comprises propyl glycidyl silsesquioxane.

4. The composition of claim 1 wherein the epoxy functional silsesquioxane is in the composition in an amount of at least 5 weight percent, based on the total weight of the resin solids of the film-forming composition.

5. The composition of claim 1 wherein the epoxy resin comprises an epoxy functional acrylic polymer.

6. The composition of claim 5 wherein the epoxy functional acrylic polymer is prepared from a methacrylate, styrene, and mixtures thereof.

7. The composition of claim 1 wherein the polyacid curing agent comprises a carboxylic acid functional resin.

8. The composition of claim 1 further comprising:
c) a polyacid curing agent comprising the reaction product of reactants comprising 1-octene, maleic anhydride copolymer, and ethanol.

9. The composition of claim 1, wherein the epoxy functional silsesquioxane is in the composition in an amount of at least 5 weight percent, based on the total weight of the resin solids of the film-forming composition; and wherein a cured coating deposited from the film-forming composition has an initial 20° gloss ranging between 70 and 90.

10. A substrate coated at least in part with a coating deposited from the film-forming composition of claim 1.

11. The substrate of claim 10 wherein the substrate comprises wood, metal, glass, cloth, plastic, foam, elastomer, and mixtures thereof.

12. A process for applying a composite coating to a substrate comprising:
(a) applying an acid-catalyzed thermosetting film-forming composition to said substrate to form a basecoat; and
(b) applying a clear film-forming composition to the basecoat wherein the film-forming composition comprises:
(1) an epoxy-containing polymer system; and
(2) a polyacid curing agent comprising at least two acid functional groups per molecule;
wherein the epoxy-containing polymer system comprises:
(i) an epoxy resin comprising at least two epoxy functional groups per molecule and which is different from (ii); and
(ii) an epoxy functional silsesquioxane.

13. The process of claim 12 wherein a cured coating deposited from the clear film-forming composition comprises:
(1) a thickness of 0.1 to 5 mils,
(2) an initial 20° gloss ranging between 70 and 90,
(3) a 20° gloss after a dry abrasion scratch test ranging between 20 and 60; and
(4) a 20° gloss after a car wash test ranging between 50 and 80.

14. The process of claim 12, wherein the substrate comprises wood, metal, glass, cloth, plastic, foam, elastomer, and mixtures thereof.

15. The process of claim 12, wherein the epoxy functional silsesquioxane comprises at least two epoxy functional groups per molecule.

16. The process of claim 12, wherein the epoxy functional silsesquioxane comprises propyl glycidyl silsesquioxane.

17. The process of claim 12, wherein the epoxy functional silsesquioxane is present in the composition in an amount of at least 5 percent by weight, based on the total weight of the resin solids of the film-forming composition.

18. The process of claim 12, wherein the epoxy resin comprises an epoxy functional acrylic polymer.

19. The process of claim 12 wherein the polyacid curing agent comprises a carboxylic acid functional resin.

20. The process of claim 12, wherein the film-forming composition further comprises c) a polyacid curing agent comprising a reaction product of reactants comprising 1-octene, maleic anhydride copolymer, and ethanol.
